(19) United States
(12) Patent Application Publication
(10) Pub. No.: US 2003/0006319 A1
(43) Pub. Date: Jan. 9, 2003

(54) Thrower system

(76) Inventors: Leonard A. Silverstein, Atlanta, GA (US); Jurgen Baumgart, Huntington Beach, CA (US)

Correspondence Address: VOLENTINE FRANCOS, P.L.L.C., Suite 150, 12200 Sunrise Valley Drive, Reston, VA, 20191, US

(21) Appl. No.: 10/163,354

(22) Filed: Jun. 7, 2002

Related U.S. Application Data
(60) Provisional application No. 60/300,069, filed on Jun. 25, 2001.

(51) Int. Cl. A01C 19/00; A62C 2/00

(52) U.S. Cl. 239/672; 239/675; 239/676; 169/36; 169/54

(57) ABSTRACT

A thrower system includes a container for storing a projectile to be thrown, a centrifugal thrower for propelling the object a distance away from the thrower system through centrifugal force, and conveying means for transporting the projectile between the container and the centrifugal thrower. The thrower system may throw baseballs, softballs, golf balls, or similar objects, and in particular, may be a cryogenic projectile thrower system. Such a cryogenic projectile thrower system is configured to include a container for storing cryogenic projectiles, a funnel hopper receiving the cryogenic projectiles from the container, a conveyer receiving the cryogenic projectiles from the funnel hopper and transporting the cryogenic projectiles to an elevated location with respect to the funnel hopper, a centrifugal thrower for propelling the cryogenic projectiles a distance away from the thrower system though centrifugal force, and a feeder receiving the cryogenic projectiles from the conveyor and dispensing the cryogenic projectiles to the centrifugal thrower.

### CROSS REFERENCES TO RELATED APPLICATIONS

This application claims the priority benefit under 35 U.S.C. §119(e) from U.S. provisional patent application No. 60/300,069, filed on Jun. 25, 2001 naming inventor Leonard A. Silverstein, the entire contents of which are hereby incorporated herein by reference for all purposes as if fully set forth herein.

### BACKGROUND AND SUMMARY OF THE INVENTION

1) Field of the Invention

In one aspect, this invention pertains to the field of catapult or thrower systems. In another aspect, this invention also pertains to the field of fire treatment, and petroleum spill retardant and cleanup, and equipment therefor.

2) Description of the Related Art

There is a continuing need for easier, faster, safer, and more effective systems and methods for treating fires. In the past, water, dry chemicals, and foam products have all been used as fire treatment materials to help extinguish fires of varying types.

It is well known that it takes a significant amount of time to extinguish certain types of fires such as forest, petroleum-based, chemical, and electrical fires using water, dry chemicals, or foam products. Water, foams, and dry chemicals also typically present a negative environmental side effect related to the clean-up of the fire treatment material.

Meanwhile, fire fighting can be very dangerous to human personnel, and consequently it is desirable to dispense fire treatment materials accurately onto a fire area from a safe distance—which can sometimes be several hundred feet or more. For example, high pressure pumps have been developed which can deliver water or other liquid out of a hose to a fire area several hundred feet away. The hose may be fairly easily aimed at the fire area in real-time by observing where the stream lands.

Moreover, fire treatment equipment needs to be easily mobile, capable of being quickly deployed to a fire treatment staging area.

Similarly, there are few effective means to retard a petroleum product spill or leak. A petroleum product leak from a ship or other vessel, for example, generally is surrounded with booms or other devices in an attempt to contain the surface spread of the spill to permit clean-up. Over time, the petroleum product may disperse, come in contact with marine life or wash up on shore, all of which create a significant adverse environmental impact. Once on shore, there currently are few, if any, effective means to eradicate the petroleum product. Petroleum leaks from ships or other vessels also are difficult to control. Presently, some of the methods to retard the leak include patching the crack or hole through which the petroleum product escapes and off-loading the petroleum product to a seaworthy vessel. There does not currently appear to be an effective method to quickly control and stop a petroleum product leak from a vessel in an environmentally friendly manner.

Accordingly, the present inventors have proposed to use solid cryogenic materials to treat and extinguish fires of the types described above. Such cryogenic materials may comprise CO₂ (“dry ice”) or a similar material. The material may be formed into solid or hollow projectiles or pellets, in the shape of cylinders, spheres, cubes, oblongs, or other shapes. Such projectiles may be extruded, or formed of compressed snow, formed of frozen liquid or gases. Moreover, the materials may include significant amounts of other compounds or materials, particularly light, inert solid materials such as Perlite. Also, the projectiles may include a light core, either encapsulated or through use of a binder. Such projectiles may be of various sizes as desired, beneficially ranging from the size of rice grains up to a diameter of 5 inches, preferably having a diameter of from 0.75 inches to 2 inches in diameter.

However, there presently exists no system or equipment to accurately deliver a large quantity of solid or hollow fire treatment material over a long distance to a fire area in a brief period of time. Further, there is no such system that can easily be relocated from place to place as needed to treat fires.

In general, there are a number of applications where it would be desirable to provide a system and method of propelling one or more small solid or hollow objects accurately over a great distance. For example, in baseball it is common for a coach to repeatedly hit baseballs several hundred feet to the outfield for catching practice. However, the inventors know of no existing equipment for automatically and accurately propelling baseballs over such a great distance.

Accordingly, it would be advantageous to provide a thrower system and method for delivering a large quantity of solid or hollow projectiles (e.g., dry ice) to a target destination located more than a few feet away from the thrower system. It would be further advantageous to provide such a thrower system that is adapted to handle and throw a cryogenic material, such as dry ice projectiles. It would be still further advantageous to provide such a thrower system that is mobile. It would also be advantageous to provide a system capable of propelling one or more small objects, such as baseballs, softballs, golf balls, and the like, accurately over a great distance. Other and further objects and advantages will appear hereinafter.

### SUMMARY OF THE INVENTION

The present invention comprises a delivery apparatus and method for delivering objects accurately to a target destination located more than a few feet away from the delivery apparatus.

In one aspect of the invention, a cryogenic projectile thrower system includes a container for storing cryogenic projectiles, a funnel hopper receiving the cryogenic projectiles from the container, a conveyer receiving the cryogenic projectiles from the funnel hopper and transporting the cryogenic projectiles to an elevated location with respect to the funnel hopper, a centrifugal thrower for propelling the cryogenic projectiles a distance away from the cryogenic projectile thrower system though centrifugal force, and a feeder receiving the cryogenic projectiles from the conveyor and dispensing the cryogenic projectiles to the centrifugal thrower. Beneficially, the cryogenic projectiles thrower system is adapted to prevent the cryogenic projectiles from sublimating and aggregating together.

In another aspect of the invention, a thrower system includes a container for storing an object to be thrown, a centrifugal thrower for propelling the object a distance away from the thrower system through centrifugal force, and conveying means for transporting the object between the container and the centrifugal thrower. The thrower system may throw baseballs, softballs, golf balls, or similar objects. Beneficially, the thrower system may include a lift mechanism for elevating the centrifugal thrower. Also beneficially, the centrifugal thrower may be adapted to be rotated in the vertical and horizontal directions.

### BRIEF DESCRIPTION OF THE DRAWINGS

FIG. 1A shows a side view of a thrower system that may be fixed or mounted onto a mobile platform;

FIG. 1B shows a top-level plan view of the thrower system of FIG. 1A;

FIGS. 2A-B illustrate the horizontal and vertical rotational movement of a centrifugal throw mechanism;

FIG. 3 illustrates a general design of a rotating throw mechanism according to a first embodiment;

FIGS. 4A-C illustrate a general design of a rotating throw mechanism according to a second embodiment.

### DESCRIPTION OF THE PREFERRED EMBODIMENTS

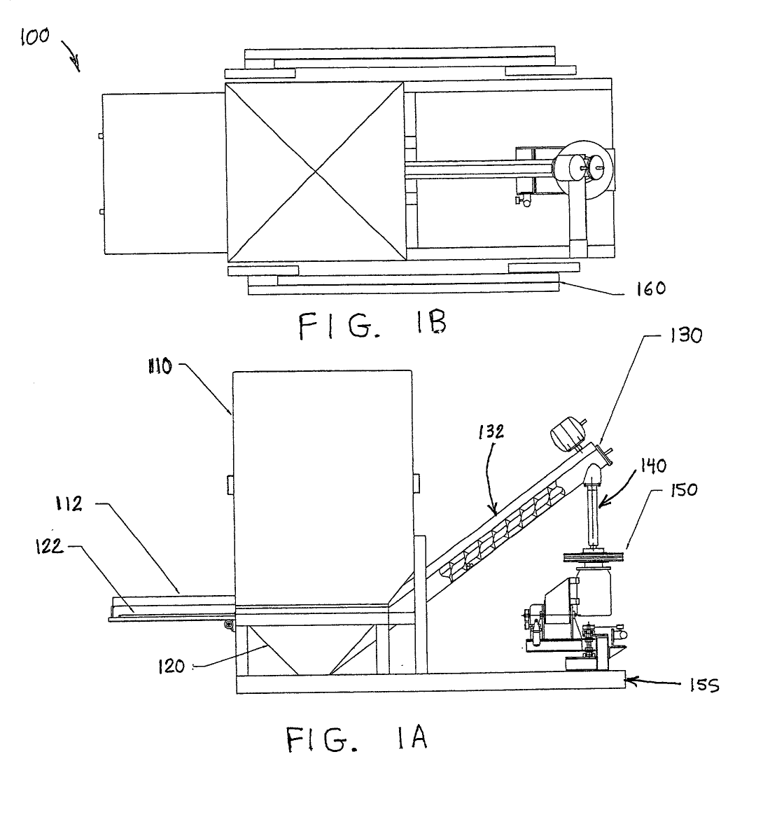

Preferred embodiments of a thrower system according to one or more aspects of the present invention may be understood by those skilled in the art from an inspection of the FIGS. 1-4C attached hereto, with reference to the following description.

As used herein, the term “projectile” encompasses solid and hollow objects of various shapes, including pellets in the shape of cylinders, spheres, cubes, oblongs, or other shapes. For the treatment of fire, such projectiles beneficially comprise a cryogenic material, such as solid (or hollow) CO₂ (“dry ice”) projectiles. Such cryogenic projectiles may be extruded, formed of compressed snow, or formed of frozen liquid or gases. Moreover, the materials may include significant amounts of other compounds or materials, particularly light, inert solid materials such as Perlite. Also, the projectiles may include a light or hollow core, either encapsulated or through use of a binder. Such projectiles may be of various sizes as desired, beneficially ranging from the size of rice grains up to a diameter of 5 inches, preferably having a diameter of from 0.75 inches to 2 inches in diameter. Aspects of a thrower system are adapted as disclosed herein to accommodate the particular characteristics of the projectiles, particularly cryogenic projectiles when the thrower is adapted to be used in the treatment of fires. Appropriate dimensions of various elements of the thrower system may be adjusted depending upon the type or size of the projectiles to be thrown.

FIG. 1A shows a side view of a thrower system 100 that may be fixed or mounted onto a mobile vehicle. The thrower system 100 comprises a container 110, a funnel hopper 120, a conveyer 130, a feeder 140, and a centrifugal thrower 150, beneficially mounted on a platform 155.

FIG. 1B shows a top-level plan view of the thrower system 100 of FIG. 1A. FIG. 1B illustrates a lift mechanism 160 that can raise and lower the platform 155, and the centrifugal thrower 150 mounted thereon. Beneficially, the lift mechanism 160 is a hydraulic lift mechanism. Beneficially, the platform can be lifted up to 30 feet. The thrower system 100 can be fixed or placed on a vehicle, like a fire truck chassis or a flat bed trailer. Its height, when in the retracted position will be sufficient to travel under highway bridges and overpasses.

The container 110 holds projectiles, and beneficially it has a retractable bottom. In operation, the projectiles are dropped out of the retractable bottom of the container 110 into the funnel hopper 120 that funnels the projectiles to the conveyor 130. Beneficially, the container 110 includes a sliding door 112 that opens the bottom of the container 110 to the hopper 120, and the hopper 120 includes a sliding cover 122 that closes the hopper during container 110 exchanges. The conveyor 130 transports the projectiles to a drop site where they are dropped into the feeder 140. Beneficially, the drop site is at an elevated location with respect to the funnel hopper. The feeder 140 feeds the projectiles into the centrifugal thrower 150. The centrifugal thrower 150 throws or propels the projectiles to an intended target area, such as a fire area. The motors 160 controlling the centrifugal thrower 150 permit the thrower system 100 to be angled along horizontal and vertical axes for directional control.

The container 110, which may or may not be insulated, is exchanged out when it is emptied, beneficially by using a lift mechanism, such as a forklift. If the thrower system 100 is designed to have a capability to “throw” several thousand (e.g., 5000-6000) pounds of projectiles per hour, then the container 110 may be designed to hold a comparable amount of projectiles. However, these numbers may be adjusted depending on a number of factors, including, for example, the size of the projectiles (e.g.: ¾ inch to 2-3 inches in diameter). Meanwhile, a truck transporting the thrower system 100 could have a second container 110 that is kept full at all times.

Beneficially, the conveyer 130 is an Archimedes screw conveyer that performs reliably with cryogenic projectiles. However, alternatively, the conveyer may comprise a moving belt, for example including a series of paddles to transport the projectiles. Other conveyers are possible. Beneficially, as shown in FIG. 1A, a slot or groove is formed along a top side of the conveyer 130 and a raised housing 132 is disposed over the slot or groove. This slot or groove is sized to permit projectiles to “pop-up” into the raised housing 132 as necessary to prevent the conveyer 130 from being jammed by projectiles out of sync with the movement of the conveyer mechanism.

In one embodiment, the thrower system 100 is adapted to deliver fire treatment materials to a target destination to treat a fire. Beneficially, the thrower system should be adapted to handle and throw cryogenic projectiles to a target destination to treat a fire as fire treatment materials. For such an application, one particularly effective type of cryogenic projectiles are dry ice (CO₂) pellets, each solid or hollow and possibly including significant amounts of other compounds or materials, particularly light, inert solid materials, such as Perlite.

A particular operation of the thrower system 100 in the application of fire treatment will now be described such that its unique features and advantages for such an application can be better understood and appreciated.

Beneficially, in that case cryogenic projectiles are transported to the thrower system 100 in an insulated container. Preferably, the container can hold a large quantity, such as several thousand pounds of cryogenic projectiles. Beneficially, the container 110 contains a retractable floor which, when opened, will permit the cryogenic projectiles to fall into the funnel hopper 120 below. The ceiling of the funnel 120 also may have a retractable ceiling which will open to permit the flow of the cryogenic projectiles from the container 110 to the funnel hopper 120.

Beneficially, the container 110 and/or funnel hopper 120 contain a means for agitating the cryogenic projectiles, such as a mixer, carbon dioxide jets, or some other apparatus to substantially prevent the cryogenic projectiles from aggregating and solidifying.

The funnel hopper 120 may have a screen to separate the projectiles from any snow that may have separated from the projectiles.

Next, the cryogenic projectiles enter the conveyor 130 that transports the projectiles upward to a drop site. Beneficially, CO₂ gas or some other cryogenic gas may be pushed through the funnel hopper 120 and conveyer 130 to maintain a cryogenic temperature at an interior thereof to minimize any sublimation of the cryogenic projectiles. Also, the gas inhibits the introduction of outside air and moisture that can sublimate the cryogenic projectiles and/or cause the cryogenic projectiles to aggregate.

Beneficially, the cryogenic projectiles are released at the top of the conveyor 130 onto a screen, again to separate from the cryogenic projectiles any snow occurring during the conveying process, and into a tube that goes to the center of the centrifugal thrower 150. As the cryogenic projectiles enter the centrifugal thrower 150, they are forced to spin around the centrifugal thrower 150.

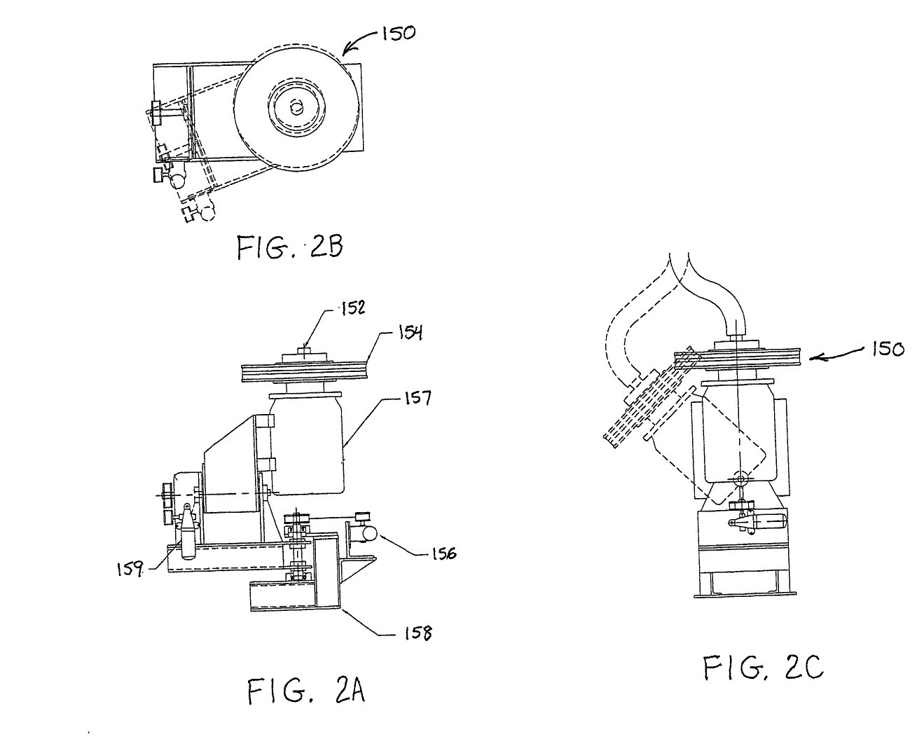

FIGS. 2A-C illustrate the horizontal and vertical rotational movement of a preferred embodiment centrifugal thrower 150. FIG. 2A shows a feed 152, a centrifugal throw wheel 154, horizontal positioning gear drive 156, variable speed motor 157, a mounting base 158, and vertical positioning gear drive 159. As can be seen in FIGS. 2A-C, the centrifugal thrower 150 is adapted to rotate in both a horizontal and vertical direction. Beneficially, the centrifugal thrower 150 is adapted to rotate over an angle of at least 50 degrees with respect to a horizontal axis, and 45 degrees with respect to a vertical axis. The cryogenic projectiles exit the centrifugal thrower 150 at a desired angle and with sufficient velocity to be propelled onto a fire located some distance away from the thrower system 100.

As described above, in other applications the thrower system 100 may operate with non-cryogenic projectiles such as baseballs, softballs, or golf balls. Appropriate dimensions of various elements of the thrower system may be adjusted depending on the size and shape of the projectiles being thrown.

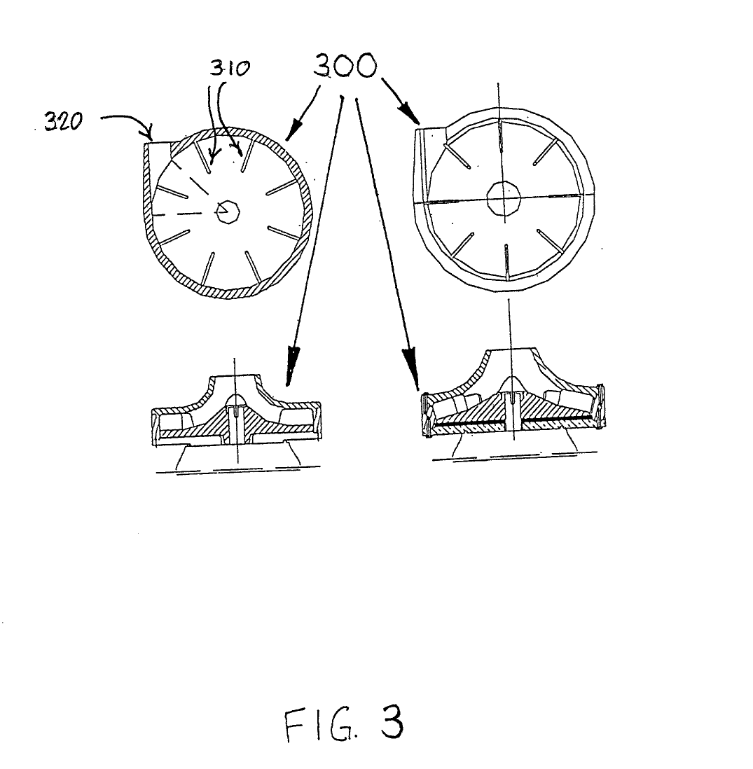

FIG. 3 illustrates a design of one embodiment of a rotating throw mechanism or wheel 300 that maybe included in the centrifugal thrower 150. The rotating throw mechanism 300 beneficially includes a plurality of fan blades 310 and a porthole 320.

The rotating throw mechanism 300 propels projectiles through the use of the fan blades 310 and centrifugal force. The centrifugal force causes the projectiles to exit a porthole 320 of the rotating throw mechanism 300 at a very high velocity sufficient to throw the projectiles a great distance. Beneficially, the centrifugal thrower 150 is adapted to have a sufficient centrifugal force to throw the projectiles at least 100 feet. More beneficially, the centrifugal thrower 150 is adapted with a sufficient centrifugal force to throw the cryogenic projectiles at least several hundred feet.

Preferably, the centrifugal thrower 150 can be angled from 0-45 degrees vertically and 0-50 degrees horizontally. These angles may be increased as desired.

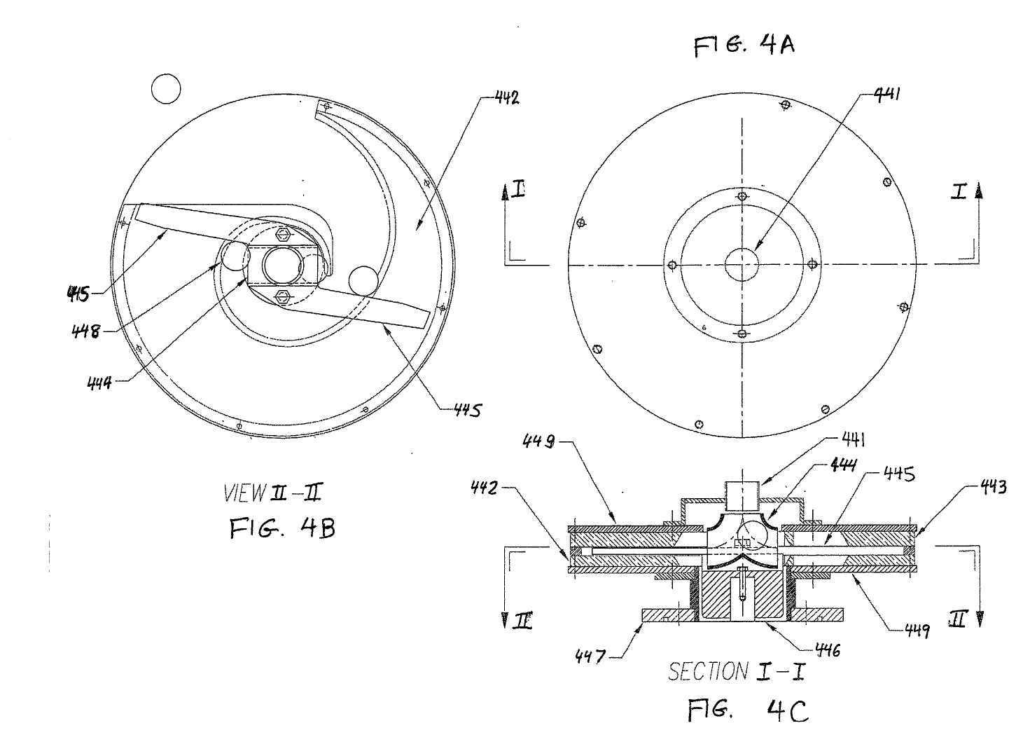

FIGS. 4A-C show details of a second embodiment of a rotating throw mechanism 400. Beneficially, the rotating throw mechanism 400 includes a scroll system for defining a path followed by a projectile as it passes through the rotating throw mechanism 400. The rotating throw mechanism 400 includes: an inlet nozzle 441 (preferably, stationary); lower and upper scroll plates 442, 443; a rotating feed tube 444 in the shape of an inverted “Y” and having integral pushers 445; a hub 446 onto which are mounted the feed tube 444 and pushers 445 and which itself mounts to a shaft of the second variable speed motor; a mounting pedestal 447 onto which are mounted the non-rotating assembly of the rotating throw mechanism 400; and closure plates 449 holding the scroll plates 442, 443.

Projectiles, such as cryogenic projectiles, enter the rotating throw mechanism 400 through the inlet nozzle 441, beneficially, by the force of gravity. From there, the projectiles fall into the rotating feed tube 444 and exit radially by centrifugal force on one or both sides of the “Y.” After a projectile exits the inverted “Y”, it is picked up by a pusher 445 and moved along the path defined by the lower and upper scroll plates 442, 443. The projectile moves outward through centrifugal force while the pusher 445 imparts it with a tangential velocity. When the projectile reaches the end of the path prescribed by the scroll plates 442, 443 it leaves the rotating throw mechanism 400 with a velocity which is the vector sum of the radial centrifugal velocity and the tangential tip speed of the pusher 445. Beneficially, the point at which the projectile leaves the rotating throw mechanism 440 is always the same and for the same rotational speed its departing velocity and direction are always the same.

In contrast to the embodiment of FIG. 3, in the embodiment of FIG. 4 projectiles enter the rotating throw mechanism imparted with a rotational speed by virtue of the rotating feed tube 444. Upon exiting the rotating feed tube 444, the projectiles are synchronized with the rotational speed of the integral pushers 445.

Also, one side of the rotating feed tube 444 in the shape of an inverted “Y” may be blocked off so that all projectiles exit from a same side of the inverted “Y.” Beneficially, the rotating feed tube 444 alters by approximately 90 degrees the direction of projectiles entering the rotating throw mechanism 400. Accordingly, instead of an inverted “Y,” alternatively the rotating feed tube 444 may take the shape of a “T” or an “elbow,” for example.

Alternatively to the embodiment shown in FIG. 4, the scroll system may comprise a single scroll plate disposed between an upper and a lower pusher.

While the invention has been shown and described with reference to a certain preferred embodiment thereof, it will be understood by those skilled in the art that various changes in form and details are possible which remain within the concept and scope of the invention. Such variations would become clear to one of ordinary skill in the art after inspection of the specification, drawings and claims herein. The invention therefore is not to be restricted except within the spirit and scope of the appended claims.

What is claimed is:

1. A cryogenic projectile thrower system, comprising:
a container adapted to store cryogenic projectiles;
a conveyer adapted to receive the cryogenic projectiles from the container and transport the cryogenic projectiles to an elevated location with respect to a bottom of the container;
a centrifugal thrower adapted to propel the cryogenic projectiles a distance away from the cryogenic projectile thrower system though at least centrifugal force; and
a feeder adapted to receive the cryogenic projectiles from the conveyor and dispense the cryogenic projectiles to the centrifugal thrower.

2. The cryogenic projectile thrower system of claim 1, further comprising a funnel hopper adapted to receive the cryogenic projectiles from the container and dispense the cryogenic projectiles to the conveyer.

3. The cryogenic projectile thrower system of claim 2, wherein an interior of the funnel hopper is adapted to maintain a cryogenic temperature sufficient to substantially control sublimation of the cryogenic projectiles.

4. The cryogenic projectile thrower system of claim 3, wherein the interior of the funnel hopper includes a cryogenic gas.

5. The cryogenic projectile thrower system of claim 1, wherein at least one of the container and the funnel hopper includes means for agitating the cryogenic projectiles.

6. The cryogenic projectile thrower system of claim 1, wherein at least one of the funnel hopper and the feeder includes a screen for separating snow from the cryogenic projectiles.

7. The cryogenic projectile thrower system of claim 1, wherein an interior of the conveyer is adapted to maintain a cryogenic temperature sufficient to substantially control sublimation of the cryogenic projectiles.

8. The cryogenic projectile thrower system of claim 7, wherein the interior of the conveyer includes a cryogenic gas.

9. The cryogenic projectile thrower system of claim 1, further comprising a lift mechanism adapted to raise and lower the centrifugal thrower.

10. The cryogenic projectile thrower system of claim 1, wherein the centrifugal thrower includes a centrifugal force throw wheel.

11. The cryogenic projectile thrower system of claim 10, wherein the centrifugal force throw wheel includes a plurality of blades and an exit port.

12. The cryogenic projectile thrower system of claim 1, wherein the centrifugal thrower comprises:
an inlet nozzle;
a pair of closure plates;
a rotating feed tube disposed between the inlet nozzle and the pair of closure plates;
at least one rotating pusher disposed between the pair of closure plates;
a scroll system disposed between the pair of closure plates;
a hub onto which are mounted the feed tube and pusher; and
a mounting pedestal onto which are mounted the inlet nozzle, scroll system, and the closure plates.

13. The cryogenic projectile thrower system of claim 12, wherein the pusher is adapted to impart tangential velocity to the cryogenic projectiles.

14. The cryogenic projectile thrower system of claim 12, further comprising a variable speed motor driving the centrifugal thrower.

15. The cryogenic projectile thrower system of claim 1, wherein the conveyer includes an Archimedes screw.

16. A thrower system, comprising:
a container;
a rotating throw mechanism, comprising
an inlet,
a pair of substantially parallel plates,
at least one pusher disposed between the substantially parallel plates, and
a feed device disposed between the inlet and the pair of substantially parallel plates; and
a conveyer extending between the container and the rotating throw mechanism.

17. The thrower system of claim 16, wherein the container is thermally insulated.

18. The thrower system of claim 16, wherein the container includes a funnel having an opening connected to the conveyer.

19. The thrower system of claim 16, wherein the rotating throw mechanism also includes a pair of scroll plates, at least a portion of the pusher being located between the scroll plates.

20. The thrower system of claim 16, wherein the pair of substantially parallel plates are fixed and the pusher rotates between the pair of substantially parallel plates.

21. The thrower system of claim 16, wherein the pusher is intregrally attached to the inlet.

22. The thrower system of claim 16, wherein the inlet alters by approximately 90 degrees a direction of a projectile entering the rotating throw mechanism.

23. The thrower system of claim 16, further comprising a drive motor attached to the inlet and pusher.

24. The thrower system of claim 16, wherein the conveyer includes a screw mechanism.

25. A thrower system, comprising:
a container adapted to store a projectile to be thrown;
a centrifugal thrower adapted to propel the projectile a distance away from the thrower system through at least centrifugal force; and
conveying means for transporting the projectile between the container and the centrifugal thrower.

26. The thrower system of claim 25, wherein the conveying means includes an Archimedes screw.

27. The thrower system of claim 25, wherein the projectile is a baseball.

28. The thrower system of claim 25, wherein the projectile is a dry ice pellet.

29. The thrower system of claim 25, wherein the projectile is hollow.

30. The thrower system of claim 25, wherein the centrifugal thrower is adapted to be rotated in horizontal and vertical directions.

31. The thrower system of claim 25, further including a lift mechanism adapted to elevate the centrifugal thrower.

32. The thrower system of claim 31, wherein the lift mechanism is a hydraulic lift mechanism.

33. The thrower system of claim 25, further including a feeder adapted to feed the projectile from the conveying means to the centrifugal thrower.

34. The thrower system of claim 25, further including a funnel adapted to feed the projectile from the container to the conveying means.
